(19) United States
(12) Patent Application Publication
(10) Pub. No.: US 2006/0242053 A1
(43) Pub. Date: Oct. 26, 2006

(54) Interactive auction style system and method for coordinating user activities

(76) Inventor: Yoni Avital, Los Angeles, CA (US)

Correspondence Address: DALINA LAW GROUP, P.C., 7910 IVANHOE AVE. #325, LA JOLLA, CA, 92037, US

(21) Appl. No.: 11/364,587

(22) Filed: Feb. 28, 2006

Related U.S. Application Data
(60) Provisional application No. 60/593,965, filed on Feb. 28, 2005.

(51) Int. Cl. G06Q 40/00

(52) U.S. Cl. 705/37

(57) ABSTRACT

Embodiments enable auction style dating comprising posting and bidding for activities which have at least a temporal component. Bids are a commitment from a bidder to attend an activity posted by a posting member that occur at a given time and possibly location. Embodiments of the invention enable an auction style online dating service that brings people with common interests together based on activities and allows for actual dating activity between a person posting an activity and a person seeking to participate in the activity through the bid process. The system allows for a real-time interactive dating service that allows a person who posts the activity to choose between bids. In addition, the system is capable of removing bids for other activities after a user has won an auction if the winning user's other bids are for activities that would not be able to be attended based on the winning bid.

This application claims priority to U.S. Provisional Patent Application No. 60/593,965 filed on Feb. 28, 2005 and entitled “Interactive Auction System Dating System and Method,” the specification of which is hereby incorporated herein by reference.

### BACKGROUND OF THE INVENTION

1. Field of the Invention

Embodiments of the invention described herein pertain to the field of computer systems. More particularly, but not by way of limitation, one or more embodiments of the invention enable auction style dating wherein users bid for activities having a temporal component.

2. Description of the Related Art

Current online dating systems utilize one way and two way matching algorithms that allow for individuals who have entered profiles to be matched with one another. One way algorithms take a first user's profile and compare that profile with a second user irregardless of the match of the second user's profile against the first user's profile. A two way matching algorithm ensures that both the first and second user's profiles match with each other.

There is currently no known system or method that enables auction style matching that comprises activities having a temporal component. For example, there is no known online service capable of auctioning an event that occurs at a specific time as a part of the matching process. In addition, current systems are not capable of prioritizing the matching for a given user so that they are not overbooked at a given time since a given user may win more than one auction and even if current systems comprised activities that occur at a given time, these online dating services would have no way of allowing a user to only book one event at a given time based on a priority.

For at least the limitations described above there is a need for system and method that allows activities having a temporal component to be bid for and prioritized enabling interactive auction dating.

### SUMMARY OF THE INVENTION

One or more embodiments of the invention enable auction style dating wherein users are able to post and bid for activities which have at least a temporal component. Bids are a commitment from a bidder to attend an activity posted by a posting member that occur at a given time and possibly location. Embodiments of the invention enable an auction style online dating service that brings people with common interests together based on activities and allows for actual dating activity between a person posting an activity and a person seeking to participate in the activity through the bid process. The system allows for a real-time interactive dating service that allows a person who posts the activity to choose between bids. In addition, the system is capable of removing bids for other activities after a user has won an auction if the winning user's other bids are for activities that would not be able to be attended based on the winning bid.

There are two types of users, “visitors” who come to search for activities but cannot bid or post activities and “members” who can post activities, place bids and be notified of the status of their bids. Members who post activities are also known as “posters”.

The service begins when a poster posts an activity having a time and possibly location. The poster can accept bids immediately at any time or hold bids until the end of the auction time. Members can bid for many different activities some of which may occur at a time and location that are mutually exclusive with respect to each other. If a given bid is chosen, the system allows for users to automatically communicate within a private area where they can plan their future activity. Members can search for available activities that match their interests and when an activity is found that a member is interested in, the member can read the poster's profile, or the system can automatically perform a match on the poster's profile to determine if the poster and bidding member are compatible. Any algorithm including one-way or two-way matching algorithms of any nature are in keeping with the spirit of the invention. When the bidding member bids on an activity, the poster's activity auction or bid list is updated. Optionally, the poster may be notified through persuasive messages via mobile devices possibly comprising SMS or MMS (picture or clip) messages detailing the benefits of choosing a particular bidder. Cell phones and other wireless devices may be utilized to respond to bids from any location at any time providing for real-time decision making and dating to occur.

A poster may add an activity that comprises an activity title, description, time and date, optional location, auction end time and optional required for introductory date flag that may be configured to allow for additional data input for example for a member that has not attended an event with the poster for example. A poster may edit the existing activity and save the changes. Embodiments of the invention may disallow activity title changes in order to prevent bait and switch activity posting whereby a user may offer an attractive activity and change the activity after bidding members have bid on the activity. The poster may also cancel or delete an activity, and embodiments of the invention may allow negative feedback to accrue for the poster in this situation. Posters may track their historical postings and members may track their historical bids. Real-time chat or telephone calls may be enabled for users when an activity is won if each user has configured their profile to allow for real-time communication after an auction win.

When a poster chooses to “accept” a winning bid, the poster agrees to attend the activity with the winning bidder and by doing so closes the activity to other members who have bid on the activity. If the poster does not select a winning bid, as is the case when a poster does not feel that the bidders are compatible with the poster, then embodiments of the invention may send all bidders a non-winning notification and the resulting auction may not allow all bidders to see if anyone had one. Other embodiments may optionally allow for the bidders to see that a given bidder had won or that no winning bidder was selected. Members may also send messages to the poster in order to convince the poster that they should be the winning bid in one or more embodiments of the invention. A poster may select at least one bid as a “hold” meaning that the bid is being treated as a “maybe”. The bidding member may at that time retain the bid or cancel the bid. Members may delete a bid at any time if the poster has not accepted the bid yet. Deleting an accepted bid may result in negative feedback for the bidder if the bidder has no winning activities that overlap the accepted bid related activity. Members can view all of their bids with respect to all activities that they have bid upon. Members may lock a poster in order to be added to all activities that a poster posts. Members may leave feedback for an activity or poster when they win an auction. For example the member may leave feedback regarding the reliability of the poster or the success of the activity. Member profiles and pictures may only be released to the poster in one or more embodiments of the invention.

Embodiments of the invention may comprise a website configured for a given language, country and region or capable of translation into another localization. Use of application services, high speed databases, parallel processors and high speed, high throughput routers and network connections allow for scalability of any magnitude depending on the required response time. Translation into various markup languages including XML and other markup languages targeted at cell phones and wireless devices having user interfaces is in keeping with the spirit of the invention.

Activities may comprise a time left to end of auction and historical feedback links allowing for bidders to ascertain the likelihood of a successful activity with the poster before posting a bid. In addition, the system may be configured to allow for searching for a specific activity or activity type and/or searching profiles of members in order to view their posted activities.

### BRIEF DESCRIPTION OF THE DRAWINGS

FIG. 1 illustrates an embodiment of an activity list for a member showing the bids associated with the member in a temporal view.

FIG. 2 illustrates an embodiment an activity detail screen.

FIG. 3 illustrates an embodiment of an auction screen available to the poster of an activity.

FIG. 4 illustrates an embodiment of the algorithm used in determining a match for an activity comprising a temporal component.

FIG. 5 illustrates a feedback approach to determine user integrity in accordance with one or more embodiments of the invention.

FIG. 6 provides a diagram that illustrates the basic modules utilized by one or more embodiments of the system to implement the interactive auction system and method for coordinating user activities.

### DETAILED DESCRIPTION OF THE INVENTION

An interactive auction dating system and method will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

One or more embodiments of the invention enable auction style dating comprising posting and bidding for activities which have at least a temporal component. Bids are a commitment from a bidder to attend an activity posted by a posting member that occur at a given time and possibly location. Embodiments of the invention enable an auction style online dating service that brings people with common interests together based on activities and allows for actual dating activity between a person posting an activity and a person seeking to participate in the activity through the bid process. The system allows for a real-time interactive dating service that allows a person who posts the activity to choose between bids. In addition, the system is capable of removing bids for other activities after a user has won an auction if the winning user's other bids are for activities that would not be able to be attended based on the winning bid.

Systems embodying one or more aspects of the inventive methodology match through activities offered by users. Users are asked to complete a profile that includes some basic information about the person. For instance a member profile might contain the user's picture and/or video, a series of attributes (tags) the user selects from a predefined list, a history of the user's activities and ratings left by the user's previous dates. For instance, if there is a user named Zach—a fan of U2's music and sushi and Zach has tickets to an upcoming U2 concert. User Zac can post the event through the system as either public or private. Public events can be browsed by any members. Private events are only available to members who Zach has pre-selected by looking at their profiles. Assume that Zach posts the U2 concert as a public event. After reviewing the event information and Zach's profile, three young ladies (Vinita, Jenny and Maria) in the same city would like to attend the concert with Zach. These users indicate through the website that they would like to attend the concert. Zach receives a notification on his mobile phone or some other device indicating that each of the ladies would like to attend. After reviewing the ladies profile, Zach decides to invite Jenny to the concert. The system provides contact information for each to set a time and place to meet before the concert. After the activity, both Zach and Jenny rate it, either positive, negative or neutral—further building each other's profile. Our method provides several advantages for both Zach and Jenny: 1) Since both agreed to the concert ahead of time, attending the activity itself is much less intimidating. 2) Activities are highly selective—Jenny would not have agreed to go to the concert unless she thought she would enjoy it. 3) Both Zach and Jenny had some validation that they share common interests by looking at the history and ratings of previous dates.

There are multiple types of users, “visitors” who come to search for activities but cannot bid or post activities and “members” who can post activities, place bids and be notified of the status of their bids. Members who post activities are also known as “posters”.

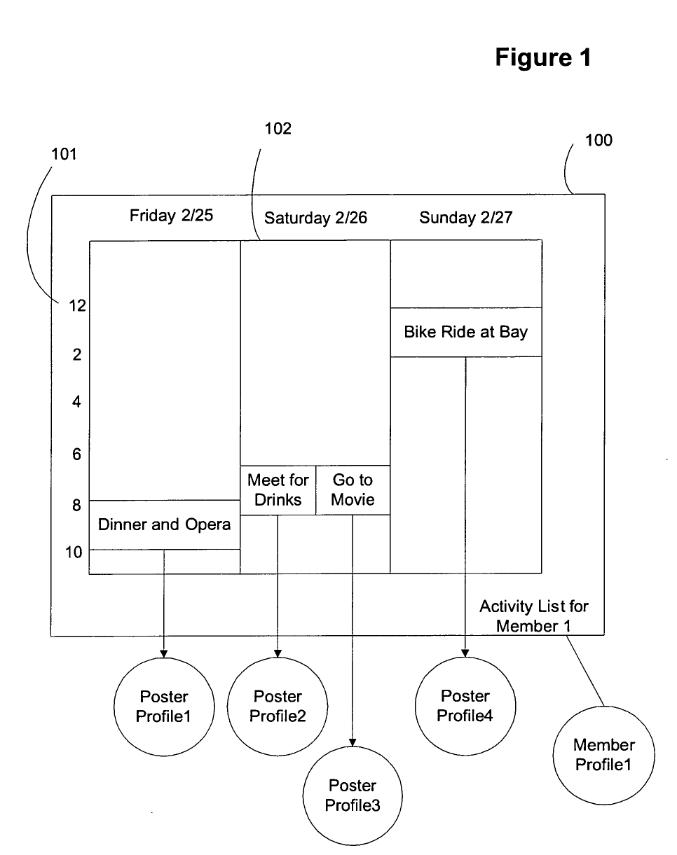

FIG. 1 illustrates an embodiment of an activity list for a member showing the bids associated with the member in a temporal view. Activity list screen 100 is associated with member 1 as shown. Activity list screen 100 comprises times 101 in the vertical axis and days 102 in the horizontal axis. Any other method of depicting activities comprising temporal qualities is in keeping with the spirit of the invention. Activity list screen 100 shows the activities that the user has bids on namely “Dinner and Opera” on February 25 at 8-10 PM, “Meet for Drinks” and “Go to Movie” a possible double booking for two entirely separate events unrelated to one another except for the time slot that they occupy and “Bike Ride at Bay”. Embodiments of the invention may be configured to remove a member from an auction when a first auction is won thereby eliminating double booking. For example if Poster 2 selects Member 1 for “Meet for Drinks” activity, then Member 1 may be automatically removed from the “Go to Movie” activity auction if the system is configured for non-overlapping bookings. If the system is configured to allow for overlapping bookings then Poster 2 and Poster 3 may be engaged in a “post off” whereby they bid against each other for Member 1. The winning poster and the member winning the auction associated with the winning poster may be notified of the winning auction result at this point. Clicking on an activity in the activity list may show the activity detail screen and may optionally show the poster's profile as well.

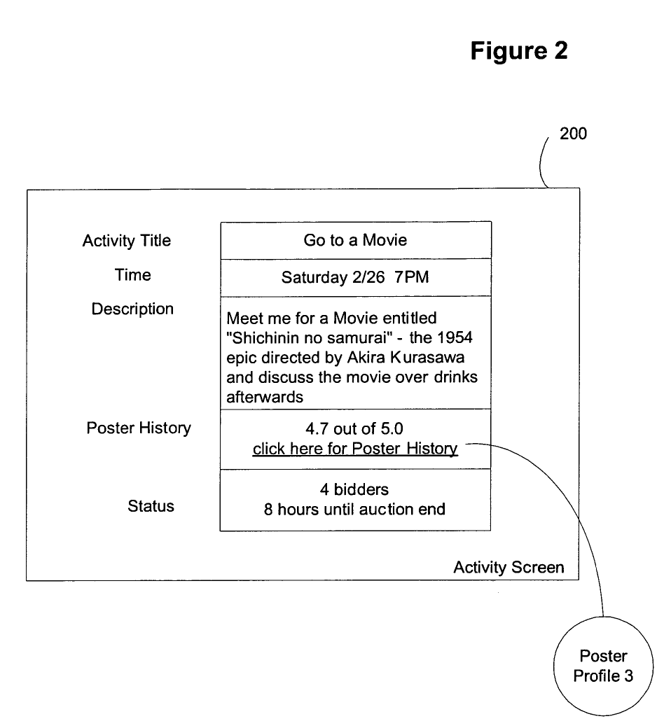

FIG. 2 illustrates an embodiment an activity detail screen. Shown are the Activity Title, Time and Date, Description, Poster History and Status of the auction. Other elements may also be displayed in order to aid in the auction process as one skilled in the art will appreciate.

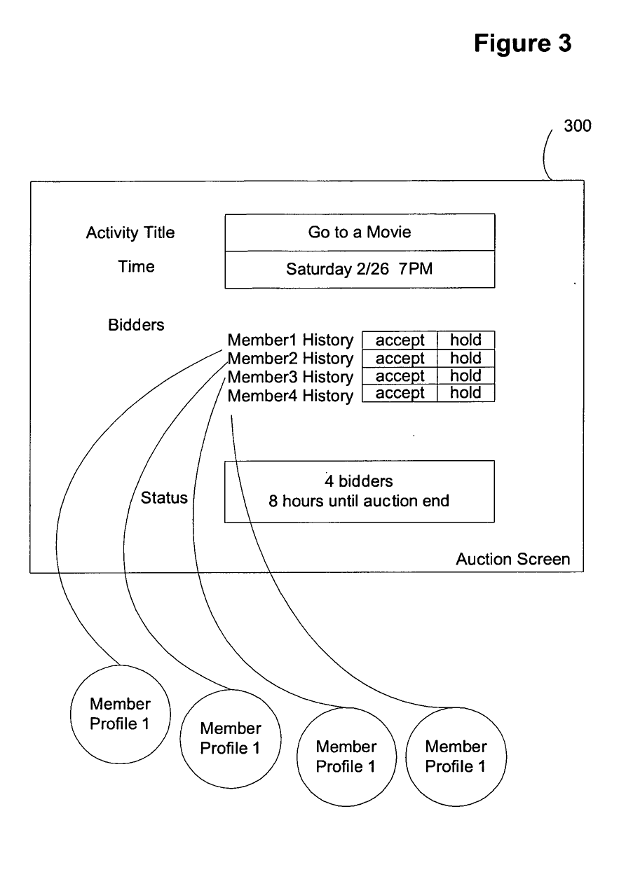

FIG. 3 illustrates an embodiment of an auction screen available to the poster of an activity. The auction screen shows the Activity Title, Time and Date, the Bidders that have current bids on the activity and a status block showing the summary of the bids on the activity. Clicking on Member History for each bidding member may show the member's history and optionally the member's profile.

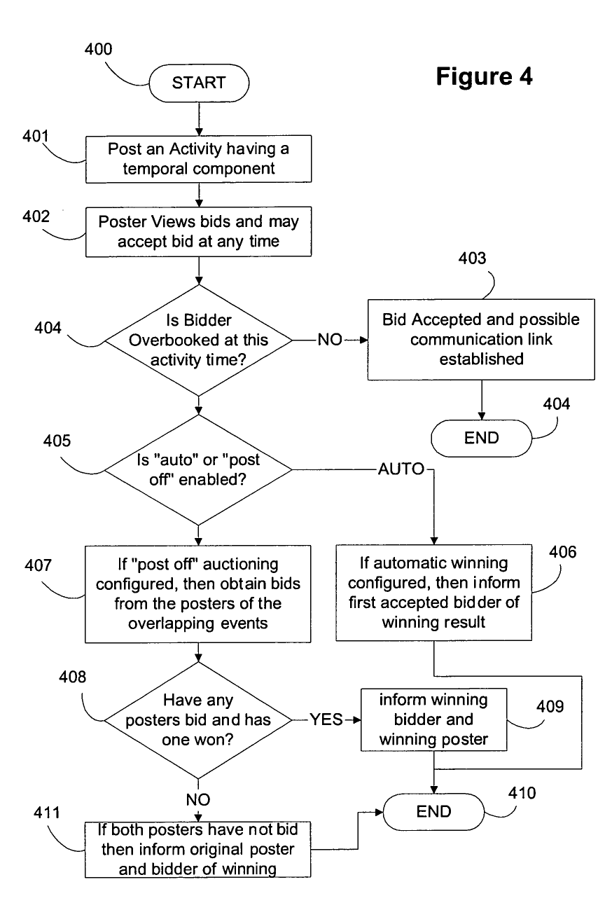

FIG. 4 illustrates an embodiment of the algorithm used in determining a match for an activity comprising a temporal component. The service begins at 400 and proceeds when a poster posts an activity having a time and possibly location at 401. The poster can accept bids immediately at any time or hold bids until the end of the auction time. If a bid is accepted and no other overlapping events have been bid upon by the member then the bid is accepted at 403 and a possible communications link is established or various messages are sent between the winning bidder and poster and the auction ends at 404. Members can bid for many different activities some of which may occur at a time and location that are mutually exclusive with respect to each other. If the auction winning bidder is overbooked meaning that the member had bids on more than one auction overlapping or close enough to overlapping in time that a plurality of events would be unattendable based on time and possibly location at 404, then if the system is configured for automatic winning at 405, the first poster who accepts the bid is the winning poster at 406. If the system (or auction) is configured for “post off” operation, then posters who have overlapping events may bid for the member's attendance at 408 and if both have done so, then the winning member and poster are informed at 409 and the process ends at 410. If no poster has bid then the original poster may be chosen as the winner of the auction and the member with the winning bid is also informed. Under all winning circumstances both the poster and member profile may be optionally automatically checked for “deal breaker” characteristics such as “smoker” when one member does not wish to perform activities with a poster that has a particular characteristic. Manual review of a profile for both parties of the auction may be performed before the auction or after the auction, however a member that does not follow through on an activity because of profile characteristics or any other reason may receive negative feedback for example. Furthermore, members can search for available profiles that match their profile and/or search strictly on activities that match their interests and when an activity is found that a member is interested in, the member can read the poster's profile, or the system can automatically perform a match on the poster's profile to determine if the poster and bidding member are compatible. Any algorithm including one-way or two-way matching algorithms of any nature are in keeping with the spirit of the invention. When the bidding member bids on an activity, the poster's activity auction or bid list is updated. Optionally, the poster may be notified through persuasive messages via mobile devices possibly comprising SMS or MMS (picture or clip) messages detailing the benefits of choosing a particular bidder. Cell phones and other wireless devices may be utilized to respond to bids from any location at any time providing for real-time decision making and dating to occur.

A poster may add an activity that comprises an activity title, description, time and date, optional location, auction end time and optional required for introductory date flag. This flag may be utilized to require additional information from a user before actually attending an event. A poster may edit the existing activity and save the changes. Embodiments of the invention may disallow activity title changes in order to prevent bait and switch activity posting whereby a user may offer an attractive activity and change the activity after bidding members have bid on the activity. The poster may also cancel or delete an activity, and embodiments of the invention may allow negative feedback to accrue for the poster in this situation. Posters may track their historical postings and members may track their historical bids. Real-time chat or telephone calls may be enabled for users when an activity is won if each user has configured their profile to allow for real-time communication after an auction win.

When a poster chooses to “accept” a winning bid, the poster agrees to attend the activity with the winning bidder and by doing so closes the activity to other members who have bid on the activity. If the poster does not select a winning bid, as is the case when a poster does not feel that the bidders are compatible with the poster, then embodiments of the invention may send all bidders a non-winning notification and the resulting auction may not allow all bidders to see if anyone had one. Other embodiments may optionally allow for the bidders to see that a given bidder had won or that no winning bidder was selected. Members may also send messages to the poster in order to convince the poster that they should be the winning bid in one or more embodiments of the invention. A poster may select at least one bid as a “hold” meaning that the bid is being treated as a “maybe”. The bidding member may at that time retain the bid or cancel the bid. Members may delete a bid at any time if the poster has not accepted the bid yet. Deleting an accepted bid may result in negative feedback for the bidder if the bidder has no winning activities that overlap the accepted bid related activity. Members can view all of their bids with respect to all activities that they have bid upon. Members may lock a poster in order to be added to all activities that a poster posts. Members may leave feedback for an activity or poster when they win an auction. For example the member may leave feedback regarding the reliability of the poster or the success of the activity. Member profiles and pictures may only be released to the poster in one or more embodiments of the invention.

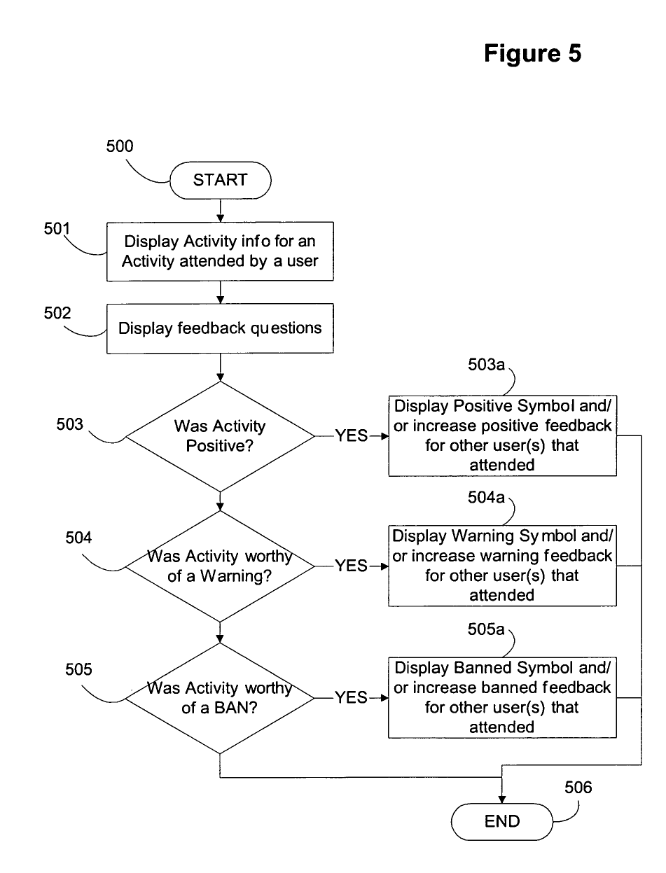

The feedback process implemented in one or more embodiments of the invention provides is depicted in FIG. 5. Processing starts at 500. User may provide many different forms of feedback and the system can be adapted to communication any such feedback about an activity that is desired. In one embodiment of the invention however, the feedback is associated with a user or an event hosted by a user and broken down into categories such as 1) warning feedback, 2) positive feedback, 3) banned. It is also feasible to give no feedback or neutral feedback. When a user initially signs up for the service the feedback is defined on a sliding scale with the starting point being neutral or no feedback. If the system identifies that the two users participated in an activity through the site (e.g., both users approved the activity and date time for the activity has passed) the system queries both users for feedback the next time they return to the web site. The activity is displayed the the activity that a user was scheduled to attend at a particular location and time when the user next enters the system at 501. This is typically accomplished through the presentation of a feedback interface designed to prompt the users with a series of questions about the activity the users participated in at 502. In one or more embodiments of the invention feedback is sought in the form of a series of YES/NO questions such as: 1) was the other user who participated in the activity reliable?; 2) is the other user's profile accurate?; 3) was the activity similar to the one suggested? Any set of questions such as shown in steps 503, 504 and 505 are in keeping with the spirit of the invention. In one or more embodiments, a yes answer to all of the questions is counted as positive feedback. Alternatively, questions may be directed at determining if the activity was a positive experience at 503, whether the activity was worth of a warning at 504 and whether the activity was worthy of a ban at 505. If any of these questions are answered yes, then a short circuit path that takes the processing through the associated display steps 503a, 504a and 505a may be taken to provide the appropriate type of feedback associated with the other user(s) attending the event. Although the form of the questions may differ the general intent and purpose is to solicit answers that confirm the integrity of users who utilize the system. The number of questions presented and the actions taken based on answers to the questions may vary in accordance with preferences set by an administrator of the system. Processing ends at 506 in the display of one or more symbols and/or text based feedback in the case of positive, warning or banned feedback. In addition, if the user does not provide feedback, then processing flows directly from step 505 to the ending step, which results in no feedback being left for the other user(s).

Embodiments of the invention may comprise a website configured for a given language, country and region or capable of translation into another localization. Use of application services, high speed databases, parallel processors and high speed, high throughput routers and network connections allow for scalability of any magnitude depending on the required response time. Translation into various markup languages including XML and other markup languages targeted at cell phones and wireless devices having user interfaces is in keeping with the spirit of the invention.

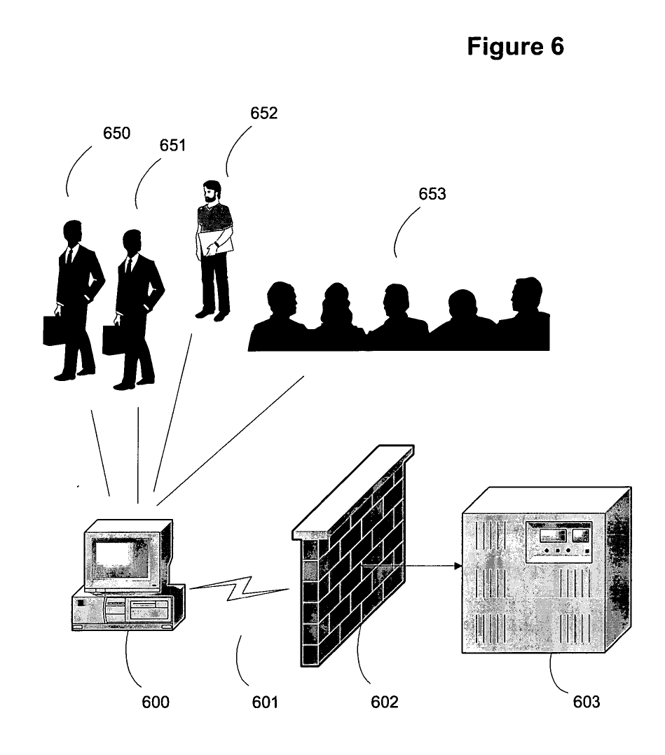

FIG. 6 provides a diagram that illustrates the basic modules utilized by one or more embodiments of the system to implement the interactive auction system and method for coordinating user activities. The system categorizes users into three types, visitor-user 652, registered-user 651 and member-user 650. As FIG. 6 depicts, visitor-user 652 can browse activities by: tags or keywords; can browse profiles of other users; can sign up in order to be a member; can read: date ideas, and access information about how the system works. Registered-user 651 is a user who has registered with the system and provided a basic amount of user information (e.g., completed a set of profile information). Registered-users can invite friends, post activities for others users to bid on and/or bid on activities other users have listed in the system. Member-user 650 is a user who has submitted payment or met other criteria as set by the system administration for being able to participate. Member-users can send messages/video chat to others, propose to other activities, post activities directly to user or users with same tags or to all sites, build their user reputation through feedback or otherwise, add other users to a favorites list and then send all of them invitation. Bidding users 653 are registered or member users. Any other level of membership is in keeping with the spirit of the invention. Users 650-653 access the system with a computing device such as computing device 600. Computing device may be of any type such as a cell phone, PDA, notebook, wireless computer or any other type of computing device configured to access Internet 601. The main system components that hold the data regarding the users is optionally shielded by firewall 602 and is held in a database running on server 603. Server 603 may comprise more than one central processing unit and/or database depending on the amount of users that the system is scaled to serve.

A group of users may post an activity inviting one or more users to an activity having a temporal component and possibly a location component. For example, two women may post an activity for a desired time and location requesting two men to meet for a social activity. All members that respond to the posting may be single posters which may add up to the required number of desired participants, or may be required to post as a group of users having the correct amount. In either case, the system checks that the bidding users are not overbooked and informs the users when they win or do not win the ability to attend the activity as per FIG. 4.

For users that have attended activities in the past and are compatible for certain activities, the user's may add each other to their “favorites” list. In adding another user to the favorites list, the poster may simply send out an event for example to given users in the favorites list or send an activity posting to all users in the favorites list. For example, the system may provide a feedback question asking a user that has attended an event if the other user is worthy of going out with again. If both users answer that this is the case, then each user is added to the other user's favorite list.

While the invention herein disclosed has been described by means of specific embodiments and applications thereof, numerous modifications and variations could be made thereto by those skilled in the art without departing from the scope of the invention set forth in the claims.

What is claimed is:

1. In a computer system, a method for interactive auction dating comprising:
obtaining an first activity description from a poster wherein said first activity description comprises a time and location for an activity wherein said first activity description comprises an auction deadline;
obtaining a first bid from a first member for said activity set to occur at said time and said location;
obtaining a second bid from a second member for said activity set to occur at said time and said location;
obtaining an input from said poster comprising a choice between said first bid and said second bid therein resulting in a winning bid associated with a winning member;
determining if said winning member associated with said winning bid has a third bid corresponding to a second activity that is unattendable based on said time and said location of said second activity with respect to said first activity; and,
removing said third bid from said second activity if said second activity is unattendable.

2. The method of claim 1 further comprising:
presenting a search screen to said first member.

3. The method of claim 1 further comprising:
performing a profile match between said first member and said second member.

4. The method of claim 1 further comprising:
notifying a posting member of said first bid and said second bid.

5. The method of claim 1 further comprising:
notifying said winning member.

6. The method of claim 1 further comprising:
notifying at least one non-winning member.

7. The method of claim 1 further comprising:
notifying all bidding members of a non-win when a posting member declines attending an activity with said all bidding members.

8. The method of claim 1 further comprising:
accepting feedback from at least one member after said at least one member has attended said activity.

9. The method of claim 1 further comprising:
presenting a question to at least one member who has attended an activity to determine if said at least one member desires to make a second at least one member a favorite.

10. The method of claim 1 further comprising:
disabling edit of said activity after said activity is posted.

11. In a computer system, a method for interactive auction dating comprising:
obtaining an first activity description from a first poster wherein said first activity description comprises a time and location for an activity wherein said first activity description comprises an auction deadline;
obtaining a first bid from a first member for said activity set to occur at said time and said location;
obtaining a second bid from a second member for said activity set to occur at said time and said location;
obtaining an input from said first poster comprising a choice between said first bid and said second bid therein resulting in a winning bid associated with a winning member;
determining if said winning member associated with said winning bid has a third bid corresponding to a second activity that is unattendable based on said time and said location of said second activity with respect to said first activity;
obtaining a first post off bid from a poster associated with said first activity and a second post off bid from a poster associated with said second activity; and,
informing a winning member and a winning poster of a successful auction result.

12. The method of claim 11 further comprising:
presenting a search screen to said first member.

13. The method of claim 11 further comprising:
performing a profile match between said first member and said second member.

14. The method of claim 11 further comprising:
notifying a posting member of said first bid and said second bid.

15. The method of claim 11 further comprising:
notifying said winning member.

16. The method of claim 11 further comprising:
notifying at least one non-winning member.

17. The method of claim 11 further comprising:
notifying all bidding members of a non-win when a posting member declines attending an activity with said all bidding members.

18. The method of claim 11 further comprising:
accepting feedback from at least one member after said at least one member has attended said activity.

19. The method of claim 11 further comprising:
presenting a question to at least one member who has attended an activity to determine if said at least one member desires to make a second at least one member a favorite.

20. The method of claim 11 further comprising:
disabling edit of said activity after said activity is posted.
